(19) United States
(12) Patent Application Publication
(10) Pub. No.: US 2015/0282426 A1
(43) Pub. Date: Oct. 8, 2015

(54) FORAGE HARVESTING MACHINE WITH AN IMPROVED DEFLECTOR

(71) Applicant: KUHN S.A., Saverne (FR)

(72) Inventors: Christian GANTZER, Woustviller (FR); Bertrand DIEBOLD, Gresswiller (FR)

(73) Assignee: KUHN S.A., Saverne (FR)

(21) Appl. No.: 14/674,337

(22) Filed: Mar. 31, 2015

(30) Foreign Application Priority Data
Apr. 8, 2014 (FR) 1453092

(51) Int. Cl. A01D 57/28

(52) U.S. Cl. CPC A01D 57/28

(57) ABSTRACT

An agricultural machine for forage harvesting, including a frame supporting a work unit able to occupy a work position in which it can pick up plants lying on the ground and shift them sideways, a side deflector being connected to the frame by a connecting device allowing the deflector to occupy an operation position relative to the work unit, in which the deflector can receive a flow of plants shifted sideways by the work unit. The connecting device is designed so that, while the machine moves in a direction and the work unit is in the work position, the deflector can perform a movement relative to the work unit from the operation position, longitudinally in a direction opposite the movement direction, when a resultant of a force exerted on the deflector exceeds a determined threshold.

### BACKGROUND OF THE INVENTION

1. Field of the Invention

The present invention relates to an agricultural machine for forage harvesting, in particular a hay-making machine for forage windrowing, comprising a frame supporting at least one work unit able to occupy a work position in which the work unit can pick up plants lying on the ground and shift them sideways, a side deflector being connected to the frame by means of a connecting device allowing the deflector to occupy an operation position relative to the work unit, in which the deflector cooperates with the work unit so as to receive a flow of plants shifted sideways by the work unit to form a windrow.

2. Discussion of the Background

A machine of this type is known from application FR 1 350 393, filed by the applicant. In this machine, the operation position of the deflector is that in which the latter is situated beside the corresponding work unit and can then, during the work of the machine, receive a flow of plants shifted sideways by said work unit. The work unit being considered substantially horizontally, the deflector in its operation position is situated at a low height above the ground. A windrow with a regular width is then formed between the deflector and the corresponding work unit. When the machine is moved for work in the fields, the deflector in its operation position may collide with a rigid obstacle present on the ground, for example a stone. The deflector may also collide with a windrow that has already been formed if the driver of the machine inadvertently fails to lift the work unit. Such risks exist when the machine is moved in its usual direction of advance for work. They also exist when the machine is maneuvered in reverse at the end or on the border of a plot, these risks in that case potentially being increased by errors in assessing the gauge of the machine or the low visibility of the deflector for the driver. A collision of the deflector with an obstacle may seriously damage the latter as well as its connecting device to the frame of the machine. A damaged deflector no longer performs its role correctly. Repairing it means lost time and creates non-negligible costs for the user of the machine.

### SUMMARY OF THE INVENTION

The present invention aims to propose an agricultural machine for forage harvesting, in particular a haymaking machine for forage windrowing, that does not have the aforementioned drawbacks.

To that end, an important feature of the invention lies in the fact that the connecting device is designed so that, while the machine moves in a direction and the work unit is in the work position, the deflector is allowed to perform at least one movement relative to the work unit from the operation position, longitudinally in a direction opposite said movement direction of the machine, when a resultant of a force exerted on the deflector exceeds a determined threshold. Thus, when the deflector collides with an obstacle, such as a stone or a relatively dense windrow, it is allowed to move longitudinally relative to the corresponding work unit, in a direction opposite the movement direction of the machine. This longitudinal movement of the deflector in the direction opposite the movement direction of the machine results in dissipating part of the energy from the impact between the deflector and the obstacle. The mechanical stresses on the deflector and its connecting device are thus reduced. The risk of one or the other of these elements being damaged to the point of hindering correct operation is greatly decreased. According to the invention, the force threshold, beyond which the deflector is allowed to move from its operation position, may be greater than the resultant of the forces normally induced on the deflector during the plant harvesting work. The resultant of the forces exerted by the plants shifted sideways by the work unit and colliding with the deflector, and the forces exerted by the rubbing of the deflector on the ground and/or with short plants present on the ground, is then insufficient for the deflector to move from its initial operation position. Said force threshold is, on the other hand, below the resultant of the forces exerted on the deflector colliding with a rigid obstacle or a dense and/or tall windrow, such that the deflector can then move from its initial operation position. Relative to the known state of the art, the connecting device according to the invention thus allows better protection for the deflector and its connecting device in case of impact, while guaranteeing that the deflector is normally maintained in its operation position during the work.

According to an important feature of the invention, the connecting device is designed so that, while the machine moves in a first direction directed forward and the work unit is in the work position, the deflector is allowed to perform a first movement relative to the work unit from its operation position, longitudinally in a direction opposite said first movement direction of the machine, when a resultant of a force exerted on the deflector and directed backward exceeds a first determined threshold. Owing to this feature, the connecting device according to the invention allows increased protection of the deflector in case of impact with an obstacle situated in front of the deflector and following the forward movement of the machine, while guaranteeing that the deflector is normally maintained in its operation position during the work.

According to a particularly advantageous feature of the invention, the connecting device is designed so that, while the machine moves in a second direction directed backward and the work unit is in the work position, the deflector is allowed to perform a second movement relative to the work unit from its operational position, longitudinally in a direction opposite said second movement direction of the machine, when a resultant of a force exerted on the deflector and oriented forward exceeds a second determined threshold. Owing to this feature, the connecting device according to the invention allows increased protection of the deflector in case of impact with an obstacle situated at the rear of the deflector and following the backward movement of the machine, while guaranteeing that the deflector is normally maintained in its operation position during the work. The aforementioned feature in particular offers better protection for the deflector during maneuvers by the machine in the field, some of which may be carried out in reverse.

According to an advantageous feature of the invention, the connecting device is designed so that the at least one longitudinal movement of the deflector from its operation position comprises an upwards translational component. Thus, the deflector is lifted from the ground at the same time that it is moved longitudinally. The deflector can thus pass over an obstacle that it encounters. The mechanical stresses and damage exerted on the deflector and the connecting device are thus greatly reduced.

### BRIEF DESCRIPTION OF THE DRAWINGS

Other features and advantages of the invention will emerge from the following description, in reference to the appended drawings, which show a non-limiting example embodiment of the machine according to the invention.

In these drawings:

FIG. 1 shows a rear perspective top view of an example embodiment of a machine according to the invention, in the work position, hitched to a tractor;

FIG. 2 shows a front perspective view of the example embodiment, in the transport position;

FIG. 3 shows a partial side view of the example embodiment, the deflector being in its operation position relative to the work unit;

FIG. 4 shows a partial side view of the example embodiment, the deflector being placed behind its operation position;

FIG. 5 shows a partial side view of the example embodiment, the deflector being placed in front of its operation position.

### DESCRIPTION OF THE PREFERRED EMBODIMENT

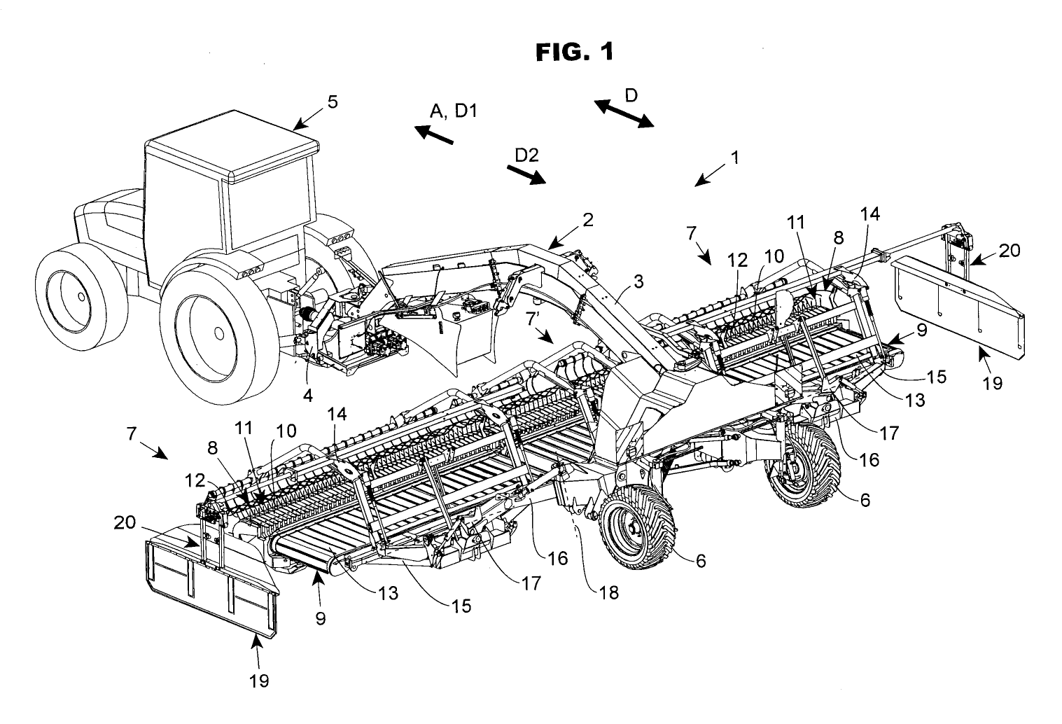

The machine 1 according to the invention is an agricultural machine for forage harvesting, in particular a haymaking machine for forage windrowing. Such a machine 1 is in particular a windrower for plants lying on the ground. The machine 1 comprises a frame 2. In the example embodiment illustrated in FIG. 1, this frame 2 comprises a more or less central longitudinal beam 3. The frame 2 further comprises a hitching device 4, which is placed at the front end of said longitudinal beam 3. The hitching device 4 makes it possible to connect the frame 2 to a motor vehicle, for example a tractor 5, in order to move the machine in a direction of advance A. In the following description, the terms “left”, “right”, “front”, “back” and “rear” refer to the direction of advance A, and the terms “upper”, “high”, “top” and “bottom” are defined relative to the ground S. A power take-off of the motor vehicle drives the various work elements of the machine 1. The frame 2 is supported on the ground S by a train of wheels 6.

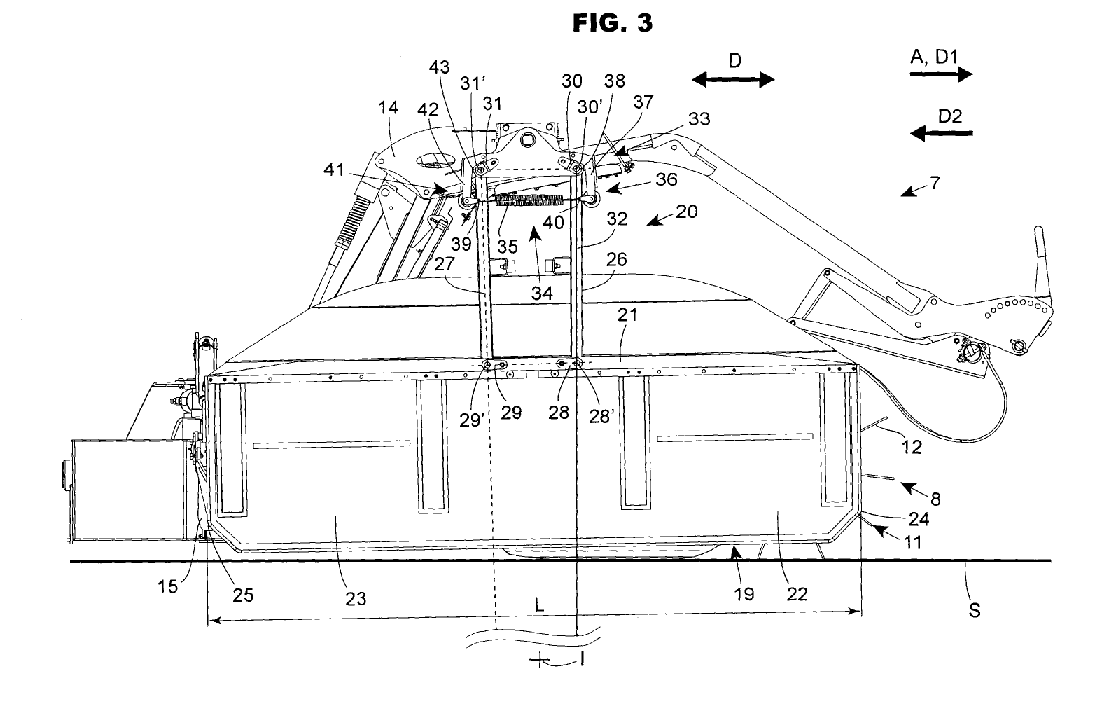

The frame 2 of the machine 1 supports at least one work unit 7. According to the example embodiment illustrated in FIG. 1, the work unit 7 is a pick-up and shifting unit for plants. This pick-up and shifting unit is for example situated, relative to the direction of advance A, between the hitching device 4 and the train of wheels 6. The work unit 7 can occupy a work position in which it can pick up plants lying on the ground S and shift them sideways. According to the example embodiment, the pick-up and shifting unit comprises a pick-up element 8 and a shifting element 9. The pick-up element 8 is of the type that can be driven during the work. It comprises a bent guiding surface 10 and a rotor 11. The rotor 11 can be driven around a rotation axis in the counterclockwise direction, seen from the right of the pick-up and shifting unit shown in more detail in FIGS. 3 to 5. In the work position of the work unit 7, this rotation axis is transverse to the direction of advance A, in particular substantially horizontal and substantially perpendicular to the direction of advance A. The pick-up element 8 comprises tines 12 that pick up the plants at the ground S, lift them and throw them backwards. The tines 12 comprise tine points that describe a curved casing when the rotor 11 is driven around the rotation axis. The tines 12 emerge at least partially from the guiding surface 10. In the example embodiment of the figures, the element 8 is of the pick-up type, the tines 12 of which are supported by the rotor 11 and emerge from the guiding surface 10 formed by a multitude of blades curved around the rotor 11 and placed next to one another along the rotation axis. The tines 12 move between these blades. In the example embodiment, the guiding surface 10 is stationary. The tines 12 are controlled such that the curved casing described by the movement of the tine points is not cylindrical. In fact, the tines 12 retract inside the guiding surface 10 when they approach an upper rear end of the guiding surface 10. In this way, the tines 12 gradually free the plants that approach the shifting element 9. Such a movement of the tines 12 is obtained for example by means of a stationary cam track, inside which rollers supported by cams connected to the tines 12 move. Alternatively, non-controlled tines 12 can also be considered. In that case, the curved casing described by the tine points is a cylinder centered on the rotation axis of the rotor 11. Other alternatives of the pick-up element 8, not shown, remain possible. According to an embodiment, the pick-up element 8 can thus comprise a flexible belt wound around a first rotor placed in front of the pick-up element 8 and around a second rotor placed further back. This second rotor may in particular be placed, in the work position of the work unit, at a distance from the ground S higher than the first rotor, such that the pick-up element 8 can move the plants that it picks up backward and upward toward the shifting element 9. Such a belt comprises tines, forks or hooks that can be fastened or articulated to the belt. In this embodiment, the guiding surface 10 is made up of the surface of the belt in contact with the plants. In that case, the guiding surface 10 is driven. The rotation axis of the rotor 11 is that of the first rotor.

The shifting element 9 for the plants is of the type that can be driven during the work. It is situated behind and near the pick-up element 8, such that it receives the plants thrown backward by the latter. This shifting element 9 comprises a conveyor 13 that moves the plants transversely to the direction of advance A. In the example embodiment of the figures, the conveyor 13 is a belt conveyor. This belt is wound around two cylinders placed at the lateral ends of the conveyor 13, between which cylinders a conveying surface of the belt which is in contact with the plants extends. These cylinders can rotate around axes oriented, in the work position of the work unit 7, for example substantially in the direction of advance A. At least one of these cylinders can be driven during the work such that the plants received from the pick-up element 8 are deposited back on the ground S in the form of a windrow so that they may subsequently be picked up again. The shifting element 9 may also be a roller conveyor, said rollers being mounted on rotation axes oriented, in the work position of the work unit 7, for example substantially in the direction of advance A. Such rollers are preferably placed next to and close to one another, and can be driven such that the plants are shifted transversely to the direction of advance A. The shifting element 9 makes it possible to transfer the plants to the left side or the right side of the work unit 7, for example to form a windrow on one side or the other.

According to an example embodiment of the invention that is not illustrated, the work unit 7 is a pick-up and shifting unit for plants lying on the ground S, of the type comprising a pick-up element formed by a rotor that can be driven around a for example substantially vertical support axis in the work position of the work unit. According to this example embodiment, the work unit 7 comprises a casing in which the support axis is fastened. Arranged below the casing is the rotor, which comprises arms extending outward. These arms are equipped with work tools, such as forks. The arms are guided in bearings rigidly fastened to the rotor such that they can pivot around their respective geometric axes oriented along the length of the arms. Provided inside the rotor is an immobile control cam that is fastened on the support axis. Each arm comprises, at its end situated in the rotor, a lever with a roller that is guided in the cam. The arms are thus controlled such that their work tools pick up the plants, in particular on the front part of their course, and shift them sideways until they are deposited in the form of a windrow in the side part of their course.

As shown in FIG. 1, the frame 2 of the machine 1 comprises a structure 14 that extends above the work unit 7. According to the example embodiment, this structure 14 extends forward from a holder 15 of the frame 2, said holder 15 supporting the work unit 7 and being situated behind it.

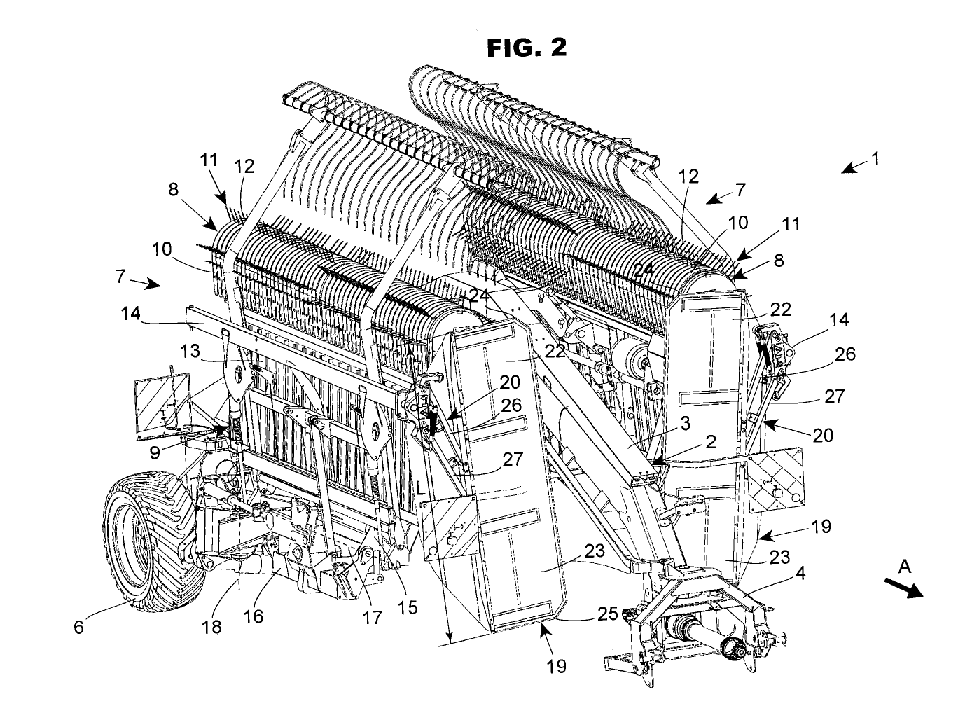

The frame 2 of the machine 1 further comprises an arm 16 supporting the work unit 7. This arm 16 is connected to the longitudinal beam 3 of the frame 2. The arm 16 is additionally connected to the holder 15, which supports the work unit 7. The arm 16 is articulated such that it allows the work unit 7 to be transposed between the work position and another position. In the work position, the work unit 7 extends transversely to the direction of advance A, in particular substantially perpendicular. It in particular extends substantially horizontally. The work unit 7 can be moved into another position. This is in particular a transport position, in which the work unit 7 is folded upwards. The work unit 7 can occupy a lifted position for example used to pass over a windrow or during maneuvers. In this lifted position, the work unit 7 is situated at some distance above the ground S. According to the example embodiment, the frame 2 comprises an axis 17 connecting the arm 16 to the holder 15. This axis 17 extends transversely when the work unit 7 is in the work position, in particular substantially parallel to the rotation axis of the rotor 11. The work unit 7 can be transposed from its work position to a first substantially vertical and transverse orientation, by pivoting upwards around the axis 17. The angle of this pivoting is for example close to 90°. By subsequent pivoting of the arm around another substantially vertical axis 18 of the frame 2, the work unit 7 is next folded against the longitudinal beam 3, for example toward the front. It is then in a second orientation close to the vertical and substantially in the direction of advance A, as shown in FIG. 2. The width of the machine 1 is thus reduced. According to the example embodiment, this second orientation corresponds to the transport position of the work unit 7, in which the latter extends substantially vertically.

As shown in FIG. 1, the machine 1 according to the invention may comprise several work units 7 in order to increase its work width. The machine 1 according to the example embodiment comprises two work units 7 placed next to one another, on either side of the longitudinal beam 3 of the frame 2. In addition, this machine comprises a central work unit 7′ placed below the longitudinal beam 3 of the frame 2. During work, the different work units 7, 7′ can for example be aligned so as to pick up a continuous strip of forage on the ground S. Their respective shifting elements 9 are then driven in the same direction so as to transfer the plants from one shifting element 9 to the adjacent shifting element 9, to ultimately form a windrow on the left side or the right side of the machine 1. It is also possible to work with the central work unit 7′ lifted in order to form a single central windrow, or a central windrow and a side windrow.

The machine 1 according to the invention comprises at least one side deflector 19. The latter is connected to the frame 2 using a connecting device 20 that allows the deflector 19 to occupy an operation position relative to the work unit 7. In this operation position, the deflector 19 is situated next to the work unit 7, substantially vertically when said work unit 7 is considered substantially horizontally. In the example embodiment illustrated in FIG. 1, a deflector 19 is arranged on the left side of the left work unit 7. Another deflector 19 is arranged on the right side of the right work unit 7; this is the one shown in more detail in FIGS. 3 to 5. The rest of the description outlines the arrangement of the right deflector 19 and its connecting device 20 to the frame 2; it is, however, clear that it may be transposed to the deflector 19 associated with the left work unit 7. In its operation position shown in FIGS. 1 and 3, the deflector 19 extends over a certain height (vertical dimension) that is substantially equal, or at least equal, to the height of the corresponding work unit 7. The deflector 19 in its operation position also has a certain length L (dimension measured in the direction of advance A). According to the example embodiment, this length L is such that, following the side view from FIG. 3, the deflector 19 at least partially hides the pick-up element 8, and furthermore completely hides the shifting element 9. The deflector 19 comprises a metal sheet or a cloth, which is preferably substantially plane. This metal sheet or cloth is held and stiffened by one or more metallic strips. The deflector 19 in particular comprises an upper strip 21 by which it is connected to the connecting device 20. The deflector 19 thus produced assumes the form of a single-piece rigid or deformable panel. In its operation position, the deflector 19 cooperates with the work unit 7 so as to receive a flow of plants shifted sideways by the work unit 7 in order to form a windrow. To that end, as shown by FIG. 3, the deflector 19 in its operation position is located at a low height from the ground S when the work unit 7 is considered substantially horizontally. Furthermore, the deflector 19 then extends substantially parallel to the ground S, such that the plants shifted sideways by the work unit 7 are stopped by the deflector 19 and do not pass below it. According to the example embodiment of the figures, these plants are moved transversely by the shifting element 9 arranged behind the pick-up element 8. The deflector 19 makes it possible to form a regular and well-delimited windrow. When the plants present on the ground S are picked up by the work unit 7 in an irregular flow for example due to density or volume variations of the cut or tedded plants present on the ground S, the presence of the deflector 19 beside the work unit 7 allows those plants to fall back onto the ground S in a windrow, the considerable homogeneity of which makes it easier to subsequently pick up using a baler or chopper.

The connecting device 20 is connected to the structure 14 that extends above the work unit 7. The deflector 19 is connected to that structure 14 of the frame 2 by the connecting device 20. According to the invention, the connecting device 20 is designed so that, while the machine moves in a direction D and the work unit 7 is in the work position, the deflector 19 is allowed to perform at least one movement relative to the work unit 7 from the operation position, longitudinally in a direction opposite said movement direction D of the machine 1, when a resultant of a force exerted on the deflector 19 exceeds a determined threshold. A movement of the deflector 19 from the operation position can be carried out in a forward movement direction D, i.e., the direction of advance A. This direction of advance A is used for the work of the machine 1, in particular when the work unit 7 must pick up and laterally shift the plants present on the ground S. This direction of advance A can also be used during maneuvers. A movement of the deflector 19 from the operation position can also be carried out in a backward movement direction D, i.e., in the direction opposite the direction of advance A, that backward movement direction D in particular being used for maneuvers. The maneuvers are for example carried out at the end of the field when the machine 1 turns around and must be precisely positioned to pick up a new strip of plants on the ground S. When the machine 1 moves for the harvesting work, the deflector 19 in its operation position may collide with an obstacle such as a stone present on the ground S, because the deflector 19 is then at a low height above the ground S. It may also collide with a relatively dense windrow if the driver of the machine 1 fails to lift the work unit 7 in time. In order to reduce the mechanical stresses experienced by the deflector 19 and the connecting device 20 during such a collision, the invention provides for the deflector 19 to be allowed to move longitudinally relative to the work unit 7, in a direction opposite the movement direction D of the machine 1. This longitudinal movement of the deflector 19 in the direction opposite the movement direction D of the machine 1 results in dissipating part of the energy of the impact between the deflector 19 and the obstacle. The damage to the deflector 19 and its connecting device 20 is thus reduced. According to the invention, the force threshold beyond which the deflector 19 is allowed to move from its operation position may be greater than the resultant of the forces normally induced on the deflector 19 during the plant harvesting work. The resultant of the forces exerted by the plants shifted sideways by the work unit 7 and colliding with the deflector 19, and the forces exerted by the rubbing of the deflector 19 on the ground S and/or with short plants present on the ground S, is then insufficient for the deflector 19 to be able to move from its initial operation position. Said force threshold is, on the other hand, lower than the resultant of the forces exerted on the deflector 19 colliding with a rigid obstacle or a dense and/or tall windrow, such that the deflector 19 can then move from its initial operation position. When the deflector 19 performs said movement from the operation position, it is moved toward another position in front of or behind said initial operation position. In this other position, the deflector 19 may nevertheless continue to receive a flow of plants shifted sideways by the work unit 7 in order to form a calibrated windrow. The example embodiment comprises this advantageous effect, because the length L of the deflector 19 is large enough so that during this forward or backward movement from the initial operation position, the deflector 19 remains in the course of the plants shifted sideways by the work unit 7.

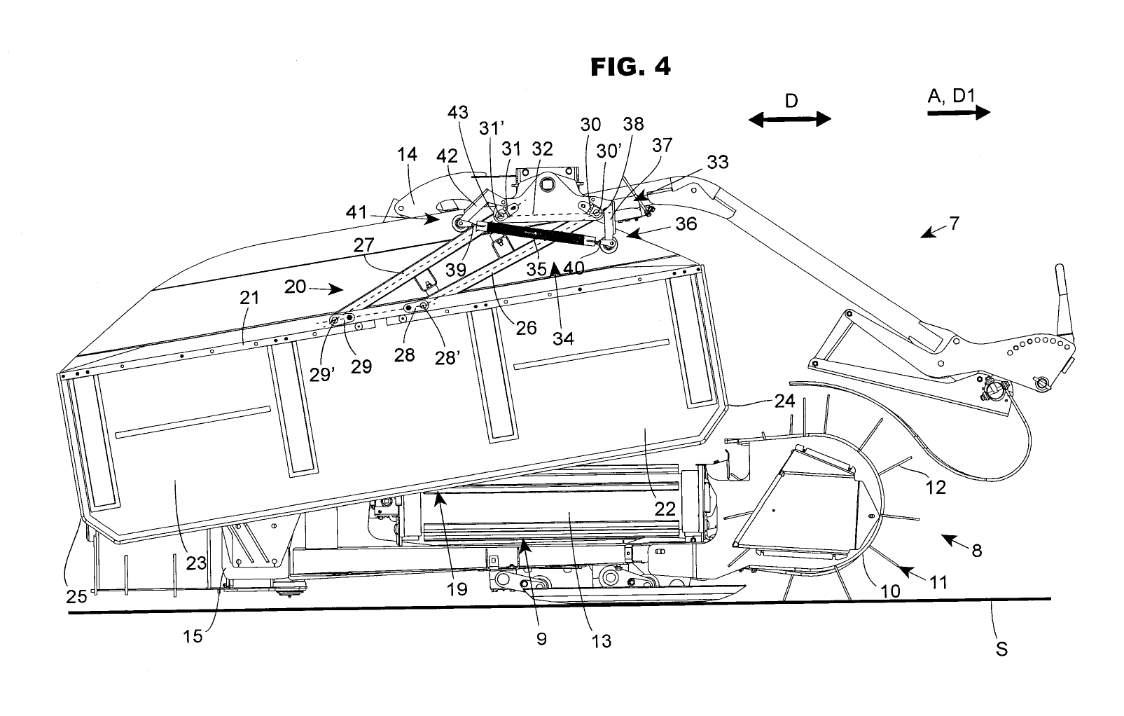

According to an important feature of the invention that emerges from an examination of FIG. 4, the connecting device 20 is designed so that, while the machine 1 moves in a first direction D1 directed forward and the work unit 7 is in the work position, the deflector 19 is allowed to perform a first movement relative to the work unit 7 from its operation position, longitudinally in a direction opposite said first movement direction D1 of the machine 1, when the resultant of a force exerted on the deflector 19 and oriented backward exceeds a first determined threshold. The connecting device 20 according to the invention thus allows increased protection of the deflector 19 in case of impact with an obstacle situated in front of the deflector 19 and following the forward movement of the machine 1, while guaranteeing that the deflector 19 is normally kept in its operation position during the work. The first direction D1 oriented forward in this case is the direction of advance A. The first force threshold beyond which the deflector 19 is allowed to move backward from its operation position may be greater than the resultant of the forces usually induced on the deflector 19 during the plant harvesting work. Thus, the resultant of the forces exerted by the plants shifted sideways by the work unit 7 and colliding with the deflector 19, and the forces exerted by the rubbing of the deflector 19 on the ground S and/or with short plants present on the ground S is insufficient for the deflector 19 to be able to move from its initial operation position. The first force threshold is, on another hand, lower than the resultant of the forces exerted on the deflector 19, the front of which collides with a rigid obstacle or a dense and/or tall windrow, such that the deflector 19 can then move backward from its initial operation position. When the deflector 19 performs the first movement from the operation position, it is moved toward another position behind said initial operation position. In this other position, one example of which is provided in FIG. 4, the deflector 19 can nevertheless continue to receive a flow of plants shifted sideways by the work unit 7 in order to form a calibrated windrow. The example embodiment comprises this advantageous effect, because the forward longitudinal extension of the deflector 19 is great enough for the deflector 19 retracted in said other position to remain in the course of the plants shifted sideways by the work unit 7. In fact, the deflector 19 has a front part 22 which, in the operation position shown in side view in FIG. 3, largely hides the pick-up element 8, whereas it is situated longitudinally at the shifting element 9 in the retracted position of the deflector 19 illustrated in FIG. 4.

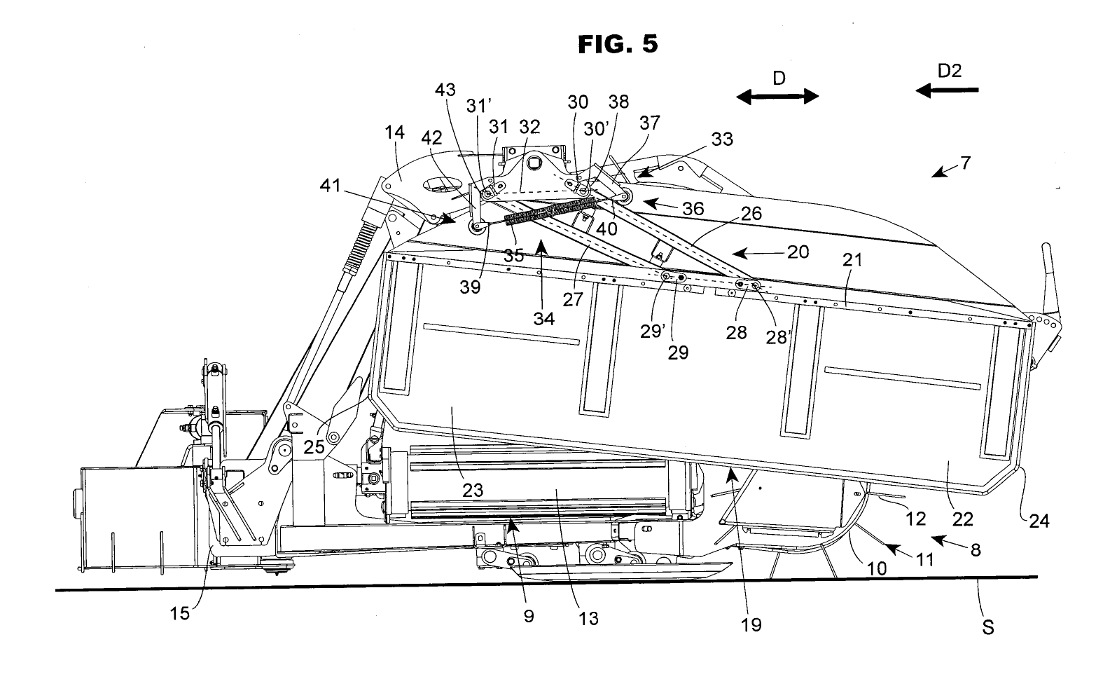

According to a particularly advantageous feature of the invention shown in FIG. 5, the connecting device 20 is designed so that, while the machine 1 moves in a second direction D2 directed backward and the work unit 7 is in the work position, the deflector 19 is allowed to perform a second movement relative to the work unit 7 from its operation position, longitudinally in a direction opposite said second movement direction D2 of the machine 1, when a resultant of a force exerted on the deflector 19 and oriented forward exceeds a second determined threshold. Owing to this feature, the connecting device 20 according to the invention allows increased protection of the deflector 19 in case of impact with an obstacle situated behind the deflector 19 and following the backward movement of the machine 1, while guaranteeing that the deflector 19 is normally kept in its operation position during the work. The aforementioned feature in particular offers better protection for the deflector 19 during reverse maneuvers of the machine 1. The second direction D2 oriented backward is in this case opposite the direction of advance A. The second force threshold is below the resultant of the forces exerted on the deflector 19 colliding, from behind, with a rigid obstacle or a dense and/or tall windrow, such that the deflector 19 can then move forward from its initial operation position. When the deflector 19 performs the second movement from the operation position, it is moved to another position in front of said initial operation position. In this other position, one example of which is provided in FIG. 5, the deflector 19 can nevertheless continue to receive a flow of plants shifted sideways by the work unit 7 in order to form a calibrated windrow. The example embodiment comprises this advantageous effect, because the backward longitudinal extension of the deflector 19 is great enough for the deflector 19 advanced in said other position to remain in the course of the plants shifted sideways by the work unit 7. In fact, the deflector 19 has a rear part 23 which, in the operation position shown in side view in FIG. 3, is situated behind the shifting element 9, whereas it is situated longitudinally at the shifting element 9 in the advanced position of the deflector 19 shown in FIG. 5.

According to an advantageous feature of the invention, the connecting device 20 is designed so that the at least one longitudinal movement of the deflector 19 from its operation position comprises an upward translational component. Thus, the deflector 19 is lifted from the ground S at the same time that it is moved longitudinally. The deflector 19 can thus pass above an obstacle that it encounters. The damage and mechanical stresses exerted on the deflector 19 and the connecting device 20 are thus greatly reduced. The at least one longitudinal movement of the deflector 19 from its operation position therefore involves an upward movement of the deflector 19. According to the example embodiment, said upward movement takes place over the entire length L of the deflector 19, i.e., the front end 24 and the rear end 25 of the deflector 19 lift during said longitudinal movement. In this way, it is the deflector 19, over its entire length L, that can pass above an obstacle that it encounters. According to the example embodiment, when the work unit 7 is in the work position, the distance between the deflector 19 and the ground S is minimal when the deflector 19 is in its operation position; on the other hand, it increases when the deflector 19 moves from its operation position. According to the example embodiment illustrated in FIG. 4, the connecting device 20 is designed so that the first longitudinal movement of the deflector 19 from its operation position comprises an upward translational component. Also according to this example embodiment, the connecting device 20 is designed so that the first longitudinal movement of the deflector 19 from its operation position involves an upward movement of the deflector 19 over the entire length L thereof, its front and rear ends 24 and 25 then both being lifted off the ground S. According to the example embodiment also illustrated in FIG. 5, the connecting device 20 is designed so that the second longitudinal movement of the deflector 19 from its operation position comprises an upward translational component. Also according to this example embodiment, the connecting device 20 is designed so that the second longitudinal movement of the deflector 19 from its operation position involves an upward movement of the deflector 19 over the entire length L thereof, its front and rear ends 24 and 25 then both being lifted off the ground S.

According to a particularly advantageous feature of the invention, the connecting device 20 is designed so that the at least one longitudinal movement of the deflector 19 from its operation position comprises a pivoting component around an axis oriented transversely in the work position of the work unit 7. Said transverse axis is in particular substantially horizontal and substantially perpendicular to the direction of advance A. According to the example embodiment, the connecting device 20 is designed so that the first longitudinal movement of the deflector 19 from its operation position comprises a pivoting component around an axis oriented transversely in the work position of the work unit 7. The example embodiment also provides that the connecting device 20 is designed so that the pivoting component of the first longitudinal movement results in lifting the front end 24 of the deflector 19 relative to the ground S. Thus, when the deflector 19 collides with an obstacle situated in front of the deflector 19, its front end 24 can rise off the ground S at the same time that it retracts relative to the work unit 7. The combined upward and rearward movement of the front end 24 of the deflector 19 contributes to the good absorption of the energy from the impact. The deflector 19 thus being oriented at an angle relative to the obstacle, it can pass over the latter more easily. According to another advantageous feature of the example embodiment, the connecting device 20 is designed so that the pivoting component of the first longitudinal movement results in placing the front end 24 of the deflector 19 at a greater distance from the ground S than the rear end 25 of the deflector 19. Thus, when the deflector 19 collides with an obstacle situated in front of the deflector 19, it retracts relative to the work unit 7, its rear end 25 rises up and its front end 24 rises up more than said rear end 25. It is therefore the deflector 19 over its entire length L which, at the same time that it retracts relative to the work unit 7, rises up off the ground S and presents itself at an angle relative to the obstacle situated in front of the deflector 19. The damage caused to the deflector 19 and the connecting device 20 is then considerably reduced. Furthermore, according to the example embodiment, the connecting device 20 is designed so that the second longitudinal movement of the deflector 19 from its operation position comprises a pivoting component around an axis oriented transversely in the work position of the work unit 7. This transverse axis may in particular be identical to that around which the pivoting component of the first longitudinal movement takes place. The example embodiment also provides that the connecting device 20 is designed so that the pivoting component of the second longitudinal movement results in lifting the rear end 25 of the deflector 19 relative to the ground S. Thus, when the deflector 19 collides with an obstacle situated behind the deflector 19, its rear end 25 can rise up off the ground S at the same time that it advances relative to the work unit 7. The combined upward and forward movement of the rear end 25 of the deflector 19 contributes to a good absorption of the energy from the impact. The deflector 19 thus being oriented at an angle relative to the obstacle, it can pass over the latter more easily. According to another advantageous feature of the example embodiment, the connecting device 20 is designed so that the pivoting component of the second longitudinal movement results in placing the rear end 25 of the deflector 19 at a greater distance from the ground S than the front end 24 of the deflector 19. Thus, when the deflector 19 collides with an obstacle situated behind the deflector 19, it advances relative to the work unit 7, its front end 24 rises up and its rear end 25 rises up more than said front end 24. It is therefore the deflector 19 over its length L which, at the same time that it advances relative to the work unit 7, rises up off the ground S and presents itself at an angle relative to the obstacle situated behind the deflector 19. The damage caused to the deflector 19 and the connecting device 20 is then considerably reduced.

According to a preferred feature of the invention, the connecting device 20 is designed so that when considering the work unit 7 extending horizontally, the at least one longitudinal movement of the deflector 19 from its operation position takes place at least essentially in a substantially vertical plane substantially parallel to the movement direction D of the machine 1. Thus, during said at least one movement, the transverse position of the deflector 19 relative to the work unit 7 remains at least substantially constant. The width of the windrow formed between the work unit 7 and the deflector 19 is therefore not affected by said at least one longitudinal movement. This feature, combined with that according to which the deflector 19 remains in the course of the plants shifted sideways by the work unit 7 when it performs said at least one longitudinal movement, allows the formation of a windrow that is well calibrated under all circumstances. Additionally, the at least one longitudinal movement of the deflector 19 from its operation position does not affect, or at least does not noticeably affect, the width of the machine 1, which remains at least substantially constant, which is advantageous if the deflector 19 collides with an obstacle while the machine 1 runs along a border situated on the side of the deflector 19. According to the example embodiment, the connecting device 20 is designed so that the at least one longitudinal movement of the deflector 19 from its operation position takes place only in a substantially vertical plane substantially parallel to the movement direction of the machine 1 (considering that the work unit 7 extends horizontally). In this example embodiment, the longitudinal movement of the deflector 19 is therefore not combined with a transverse movement relative to the work unit 7. According to the example embodiment, the connecting device 20 is designed so that the first longitudinal movement of the deflector 19 from its operation position takes place at least essentially in a substantially vertical plane substantially parallel to the movement direction D of the machine 1 (considering that the work unit 7 extends horizontally). In the case at hand, this first movement takes place only in said plane. The example embodiment also provides that the connecting device 20 is designed so that the second longitudinal movement of the deflector 19 from its operation position takes place at least essentially in a substantially vertical plane substantially parallel to the movement direction D of the machine 1 (considering that the work unit 7 extends horizontally). In the case at hand, this second movement Occurs only in said plane. According to the example embodiment, considering the work unit 7 extending horizontally, the longitudinal movement of the deflector 19 from its operation position, both forward and backward relative to the work unit 7, takes place in a same substantially vertical plane substantially parallel to the direction of advance A. The width of the windrow thus formed as well as the width of the machine 1 therefore remain constant irrespective of the movement direction of the deflector 19 following a collision with an obstacle.

According to the example embodiment, the connecting device 20 comprises two bars 26 and 27, and each bar 26, 27 is connected to the frame 2 and the deflector 19. This feature differentiates the connecting device 20 according to the invention from the known state of the art cited in the introduction, in which the deflector 19 is connected to the frame 2 using a bar with a small section. This solution has the drawback that a single bar may easily be bent and its respective connections to the frame and the deflector may quickly lose play. In contrast, the connecting device 20 with two bars 26 and 27 according to the invention allows the deflector 19 to be kept firmly in its operation position and well guided during the at least one movement from its longitudinal position. According to the example embodiment, each bar 26, 27 assumes the form of a rigid connecting-rod. Each bar 26, 27 is respectively connected to the frame 2 and the deflector 19 by means of a respective articulation 28, 29, 30, 31. According to other embodiments not shown, a bar 26, 27 may be deformable, for example be made up of a spring plate or a bar with programmed deformation. Such a deformable bar 26, 27 may be connected to the frame 2 and the deflector 19 in an articulated or rigid manner.

The invention advantageously provides that the two bars 26 and 27 are articulated around articulation axes 28′, 29′, 30′, 31′ which, considering the work unit 7 extending horizontally, are substantially horizontal and substantially perpendicular to the movement direction D of the machine 1. This feature allows a longitudinal movement of the deflector 19 from its operation position, both forward and backward relative to the work unit 7, in a same substantially vertical plane substantially parallel to the direction of advance A.

According to a preferred feature of the invention comprised by the example embodiment, in the operation position of the deflector 19, considering the work unit 7 extending horizontally, the respective projections of the two bars 26 and 27 in a vertical plane parallel to the movement direction D of the machine 1 each have an orientation close to the vertical, and said projections form a deformable quadrilateral 32. The sides of the deformable quadrilateral 32 are made up of the straight line segments connecting the connecting points of the two bars 26 and 27 to the structure 14 of the frame 2, in the case at hand the articulation axes 28′ and 29′, 29′ and 30′, 30′ and 31′, 31′ and 28′ of the two bars 26 and 27. The two bars 26 and 27 are spaced apart from one another in the direction of advance A. Thus, said projections form, in said plane, a deformable quadrilateral 32 that can be a rectangle, a parallelogram or a trapezoid. The example embodiment shows the latter case. The preferred feature previously mentioned allows movement kinematics of the deflector 19 that are substantially symmetrical on either side of the operation position. In other words, the backward movement course of the deflector 19 from its operation position is, relative to the latter, substantially symmetrical to the forward movement course. Thus, the capacity of the deflector 19 to retract effectively with respect to an obstacle is substantially the same in both directions. Furthermore, the aforementioned preferred feature causes the distance from the ground S to the deflector 19 to be minimal in its operation position when the work unit 7 is in its work position, and any longitudinal movement of the deflector 19 from this operation position is necessarily combined with an upward movement of the deflector 19. Depending on the configuration of the deformable quadrilateral 32, this longitudinal movement of the deflector 19 may be combined with a pivoting of the deflector 19 around a transverse axis.

In the example embodiment, at least in the operation position of the deflector 19, considering the work unit 7 extending horizontally, the connecting device 20 extends in a substantially vertical plane substantially parallel to the direction of advance A. This feature makes the connecting device 20 not very bulky in a direction perpendicular to the direction of advance A. Thus, the connecting device 20 does not reduce the width of the space available between the work unit 7 and the deflector 19, that space being crossed through by the flow of plants shifted sideways by the work unit 7 toward the deflector 19. During the work, the risk of those plants becoming wound around the connecting device 20 is therefore reduced. According to the example embodiment illustrated by the figures, these advantages are obtained by the fact that when considering the work unit 7 extending horizontally and the deflector 19 extending in its operation position, the two bars 26 and 27 each have an orientation close to the vertical.

According to the example embodiment, the two bars 26 and 27 forming the deformable quadrilateral 32 connecting the deflector 19 to the frame 2 are arranged such that the deformable quadrilateral 32 has an instantaneous rotation center I situated, in the work position of the work unit 7 and in the operation position of the deflector 19, below the surface of the ground S. The instantaneous rotation center I is the point where the two bars 26 and 27 or the straight lines passing through their connection points 28′, 30′ and 29′, 31′ intersect. In the example embodiment, this instantaneous rotation center I is the virtual point of intersection of the extensions of the two bars 26 and 27, i.e., the virtual point of intersection of the straight lines passing through the articulation axes 28′, 30′ and 29′, 31′. The advantage of providing the instantaneous rotation center I below the surface of the ground S when the deflector 19 is in its operation position is that a slight longitudinal movement of the deflector 19 on either side of its operation position essentially comprises a longitudinal translational component, but a small vertical translational component. Thus, small longitudinal movements of the deflector 19 forward or backward from its initial operation position, due during the work to moderate height or density variations of the plants spread on the ground S, still have substantially no effect on the vertical position of the deflector 19 relative to the work unit 7. According to the example embodiment, the instantaneous rotation center I of the deformable quadrilateral 32 situated below the surface of the ground S when the deflector 19 is in its operation position, further allows the front end 24 of the deflector 19 to be raised off the ground S during the first backward movement, and the rear end 25 of the deflector 19 to rise off the ground S during the second forward movement. According to the example embodiment, the instantaneous rotation center I of the deformable quadrilateral 32 is even situated clearly below the ground S when the deflector 19 is in its operation position, by a distance in particular comprised between two and fifty times, in particular between five and twenty times, the height of the deflector 19. This makes it possible, during the first longitudinal movement, for the deflector 19 to rise up over its entire length L at the same time that its front end 24 rises up more than its rear end 25. Likewise, during the second longitudinal movement, the deflector 19 rises up over its entire length L at the same time that its rear end 25 rises up more than its front end 24.

According to an advantageous feature of the invention, the connecting device 20 comprises a resetting device 33 for resetting the deflector 19 in its operation position. This resetting device 33 has at least two functions. First, it keeps the deflector 19 in its operation position while the deflector 19 undergoes only the forces exerted by the plants shifted sideways by the work unit 7 and colliding with the deflector 19, and by the rubbing of the deflector 19 on the ground S and/or with short plants present on the ground S. Secondly, the resetting device 33 nevertheless allows the deflector 19 to leave its operation position when the forces on the deflector 19 are greater, in particular during a collision of the deflector 19 with a rigid obstacle or a tall and/or high density windrow. After the deflector 19 has retracted faced with the obstacle by performing the movement according to the invention (first backward movement or second forward movement, depending on the case), the resetting device 33 automatically returns the deflector 19 to its initial operation position. In order to perform these various functions, the resetting device 33 may comprise at least one force mean 34, in particular at least one elastic force mean 35 such as a spring, articulated between the connecting device 20 and the frame 2. The resetting device 33 in the case at hand comprises a single elastic force mean 35 connected to the connecting device 20 and the frame 2 such that this elastic force mean 35 has an idle configuration when the deflector 19 is in its operation position. This idle configuration is in particular a minimum tension configuration of the elastic force mean 35. Additionally, a same longitudinal movement value of the deflector 19 forward or backward from its operation position causes an identical stress of the elastic force mean 35 then leaving its idle configuration.

In the case at hand, the resetting device 33 comprises a first force mean 36 that determines the first force threshold beyond which the deflector 19 is allowed to perform the first movement from its operation position. According to the example embodiment, the first force mean 36 comprises an elastic force mean 35 such as a spring, articulated directly or indirectly between the connecting device 20 and the frame 2. The elastic force mean 35 acts between a first small connecting-rod 37, articulated to the frame 2 and placed in front of the connecting device 20, and a bar of the connecting device 20, in the case at hand the one 27 positioned at the rear. In the operation position of the deflector 19, the first small connecting-rod 37 bears against a first stop 38 of the frame 2. When the deflector 19 performs the first backward movement relative to the work unit 7, the bar 27 situated behind the connecting device 20 causes the rear end 39 of the elastic force mean 35, the front end 40 of which is retained by the first small connecting-rod 37 bearing against the first stop 38, to retract. The elastic force mean 35 is then stressed in elongation, such that it has a tension greater than that in its idle configuration.

Furthermore, the resetting device 33 comprises a second force mean 41 that determines the second force threshold beyond which the deflector 19 is allowed to perform the second movement from its operation position. According to the example embodiment, the second force mean 41 comprises an elastic force mean 35 such as a spring, articulated directly or indirectly between the connecting device 20 and the frame 2. This elastic force mean 35 acts between a second small connecting-rod 42, articulated to the frame 2 and placed behind the connecting device 20, and a bar of the connecting device 20, in the case at hand the one 26 positioned in front. In the operation position of the deflector 19, the second small connecting-rod 42 bears against a second stop 43 of the frame 2. When the deflector performs the second forward movement relative to the work unit 7, the bar 26 situated in front of the connecting device 20 causes the front end 40 of the elastic force mean 35, the rear end 39 of which is retained by the second small connecting-rod 42 bearing against the second stop 43, to advance. The elastic force mean 35 is then stressed in elongation.

As shown in FIGS. 3 to 5, the first force mean 36 and the second force mean 41 comprise the same and single elastic force mean 35, which operates as described above. This elastic force mean 35 connects the first small connecting-rod 37 and the second small connecting-rod 42 to each other. The first small connecting-rod 37 is placed in front of the front bar 26 of the connecting device 20. This front bar 26 is in contact with the first small connecting-rod 37 in the operation position of the deflector 19 and when the latter performs the second forward movement. On another hand, the front bar 26 moves away from the first small connecting-rod 37 during the first backward movement of the deflector 19. The second small connecting-rod 42 is placed behind the rear bar 27 of the connecting device 20. That rear bar 27 is in contact with the second small connecting-rod 42 in the operation position of the deflector 19 and when the latter performs the first backward movement. On another hand, the rear bar 27 moves away from the second small connecting-rod 42 during the second forward movement of the deflector 19.

According to the example embodiment, the work unit 7 is pivoted around the vertical axis 18 of the frame 2 so that it may be placed in transport position, the deflector 19 therefore being situated in the longitudinal extension of the work unit 7 in transport position. Since this transport position, illustrated in FIG. 2, is also obtained by pivoting the work unit 7 around the axis 17 of the holder (said axis 17 being oriented transversely in the work position), the length L of the deflector 19 has an orientation closer to the vertical when the work unit 7 is in the transport position. As a result, in the transport position, the deflector 19 fits into the transverse bulk of the machine 1 and does not increase the latter. According to the example embodiment, in the transport position, the deflector 19 extends to the front of the work unit 7, substantially at the vertical, in a transverse plane. According to an advantageous feature of the invention, the connecting device 20 allows the deflector 19 to perform the at least one movement from the operation position relative to the work unit 7, in order to lower the deflector 19 toward the ground S. According to the example embodiment, the deflector 19 placed in front of the work unit 7 in the transport position is brought closer to the ground S by performing the first movement from the operation position of said deflector 19. Thus, the connecting device 20 allows a reduction in the total height of the machine 1 during transport and a lowering of its center of gravity. According to the example embodiment, the movement of the deflector 19 toward the ground S from its operation position takes place automatically when the work unit 7 is transposed from its work position to its transport position. This is obtained by the fact that in the transport position of the work unit 7, the inherent weight of the deflector 19 is greater than the return force exerted by the elastic force mean 35 on the deflector 19, the deflector 19 therefore being allowed to perform the first movement toward the ground S automatically.

The invention is of course not limited to the example embodiment described above and shown in the appended figures. Modifications remain possible, in particular regarding the composition, arrangement or number of the various elements, by combining various aforementioned features, or by substituting technical equivalents, without going beyond the scope of protection of the invention.

What is claimed as new and desired to be secured by Letters Patent of the United States is:

1. An agricultural machine for forage harvesting, in particular a haymaking machine for forage windrowing, including a frame supporting a work unit able to occupy a work position in which the work unit can pick up plants lying on the ground and shift them sideways, a side deflector being connected to the frame by a connecting device allowing the deflector to occupy an operation position relative to the work unit, wherein the deflector cooperates with the work unit so as to receive a flow of plants shifted sideways by the work unit to form a windrow, wherein the connecting device is designed so that, while the machine moves in a direction and the work unit is in the work position, the deflector is allowed to perform a movement relative to the work unit from the operation position, longitudinally in a direction opposite said movement direction of the machine, when a resultant of a force exerted on the deflector exceeds a determined threshold.

2. The agricultural machine according to claim 1, wherein the connecting device is designed so that, while the machine moves in a first direction oriented forward and the work unit is in the work position, the deflector is allowed to perform a first movement relative to the work unit from its operation position, longitudinally in a direction opposite said first movement direction of the machine, when a resultant of a force exerted on the deflector and oriented backward exceeds the first determined threshold.

3. The agricultural machine according to claim 1, wherein the connecting device is designed so that, while the machine moves in a second direction directed backward and the work unit is in the work position, the deflector is allowed to perform a second movement relative to the work unit from its operation position, longitudinally in a direction opposite said second movement direction of the machine, when a resultant of a force exerted on the deflector and oriented forward exceeds a second determined threshold.

4. The agricultural machine according to claim 1, wherein the connecting device is designed so that the longitudinal movement of the deflector from its operation position comprises an upward translational component.

5. The agricultural machine according to claim 1, wherein the connecting device is designed so that the longitudinal movement of the deflector from its operation position comprises a pivoting component around an axis oriented transversely in the work position of the work unit.

6. The agricultural machine according to claim 5, wherein the connecting device is designed so that the pivoting component of the first longitudinal movement results in placing a front end of the deflector at a greater distance from the ground than a rear end of the deflector.

7. The agricultural machine according to claim 5, wherein the connecting device is designed so that the pivoting component of the second longitudinal movement results in placing a rear end of the deflector at a greater distance from the ground than a front end of the deflector.

8. The agricultural machine according to claim 1, wherein the connecting device is designed so that when considering the work unit extending horizontally, the longitudinal movement of the deflector from its operation position takes place in a vertical plane parallel to the movement direction of the machine.

9. The agricultural machine according to claim 1, wherein the connecting device comprises two bars, and each bar is connected to the frame and the deflector.

10. The agricultural machine according to claim 9, wherein the two bars are articulated around articulation axes which, when considering the work unit extending horizontally, are horizontal and perpendicular to the movement direction of the machine.

11. The agricultural machine according to claim 9, wherein in the operation position of the deflector, when considering the work unit extending horizontally, the respective projections of the two bars in a vertical plane parallel to the movement direction of the machine each have an orientation close to the vertical, and the projections form a deformable quadrilateral.

12. The agricultural machine according to claim 9, wherein the two bars form a deformable quadrilateral connecting the deflector to the frame, which deformable quadrilateral has an instantaneous rotation center situated, in the work position of the work unit and in the operation position of the deflector, below the surface of the ground.

13. The agricultural machine according to claim 1, wherein in the operation position of the deflector, when considering the work unit extending horizontally, the connecting device extends in a vertical plane parallel to the direction of advance.

14. The agricultural machine according to claim 1, wherein the connecting device includes a resetting device for resetting the deflector in its operation position.

15. The agricultural machine according to claim 2, wherein the resetting device comprises a first force mean that determines the first force threshold beyond which the deflector is allowed to perform the first movement.

16. The agricultural machine according to claim 3, wherein the resetting device includes a second force mean that determines the second force threshold beyond which the deflector is allowed to perform the second movement.

17. The agricultural machine according to claim 1, wherein the work unit can be transposed into a transport position and the connecting device allows the deflector to perform the movement from its operation position relative to the work unit, in order to lower the deflector toward the ground.
